(19) United States
(12) Patent Application Publication
(10) Pub. No.: US 2005/0192144 A1
(43) Pub. Date: Sep. 1, 2005

(54) Adjusting device of belt tension

(76) Inventor: Yasuhiro Yokoyama, Kawasaki-shi (JP)

Correspondence Address: JACOBSON HOLMAN PLLC, 400 SEVENTH STREET N.W., SUITE 600, WASHINGTON, DC, 20004, US

(21) Appl. No.: 11/050,449

(22) Filed: Feb. 4, 2005

(30) Foreign Application Priority Data
Feb. 6, 2004 (JP) 2004-31260

(51) Int. Cl. F16H 7/08; F16H 7/12

(52) U.S. Cl. 474/117; 474/110; 474/133

(57) ABSTRACT

A belt tension adjusting device is composed so that a part of the force producing the bending moment exerting to the connecting arm supporting shaft (6) attached to the engine body and supporting the connecting arm (8) for rocking is transmitted to the auto-tensioner supporting shaft (15) attached to the engine body and fixing the fixing end (32c) of the actuator (32), in order to reduce the bending moment exerting to the connecting arm supporting shaft (6). The device comprises a crank pulley (1), an accessory drive pulley, a tension pulley (5), a belt (2) to transmit the torque of the crank pulley to the accessory pulley, an auto-tensioner (3) (automatic belt tension adjuster) for adjusting the tension of the belt (2) through shifting the center position of the tension pulley (5) by an actuator (32), a connecting arm (8) for connecting the moving end (32d) of the actuator (32) and the tension pulley (5), a reinforcing member (10) bridging the fixing end (32c) of the actuator (32) and the connecting arm supporting shaft (6).

### BACKGROUND OF THE INVENTION

1. Field of the invention

The present invention relates to a belt tension adjusting device to be applied to an engine mounted on a vehicle, etc., the device comprising an accessory drive pulley connected to a crank pulley of an engine by means of a belt; a tension pulley for adjusting the tension of the belt; and an auto-tensioner (automatic belt tension adjuster) for adjusting belt tension; the fixing end of the auto-tensioner being fixed to the body of the engine, the moving end of an actuator of the auto-tensioner being connected to an end of a connecting arm, the tension pulley being supported for rotation at the other end of the connecting arm, the connecting arm being supported for rocking at an intermediate position between both ends by a supporting shaft attached to the engine body, whereby the tension of the belt being able to be adjusted through changing the center position of the tension pulley by shifting the moving end of the actuator.

2. Description of the Related Art

As for belt transmission for driving accessories of an engine, belt tension adjusting devices are disclosed for example in JP2002-276748A, JP2002-323101A, and JP2003-27953A. The device having a tension pulley for adjusting the tension of the belt and an auto-tensioner (automatic belt tension adjuster) which is composed such that the position of rotation center of the tension pulley is moved by shifting the moving end of an actuator, the moving end being connected to the tension pulley by means of a connecting arm. Particularly, Japanese Laid-Open Patent Application No. 2002-276748, the arm supporting the tension pulley for rotation is supported by a single, relatively long supporting shaft (bolt) screwed into the engine body, and the screw part of the shaft must bear the bending moment due to the force exerting to the arm.

In FIG. 11-FIG. 15 is shown an example of belt tension adjusting device of prior art for a vehicle engine, which comprises a tension pulley and an auto-tensioner comprising a connecting arm supporting the tension pulley for rotation, and in which the connecting arm is supported by a single, relatively long supporting shaft (bolt) screwed into the engine body. FIG. 11 is a side view along the crankshaft center line, FIG. 12 is an elevation viewed in the direction of the crankshaft center line, FIG. 13 is an elevational view of the auto-tensioner, and FIG. 14 is an elevational view of the auto-tensioner when it is clutched by a holding tool for holding the actuator in a contracted state when replacing the belt. FIG. 15(A) is an enlarged detail of a part indicated by arrow Y in FIG. 12, and FIG. 15(B) is a view in the direction of arrow Z in FIG. 15(A).

In the drawings, reference numeral 105 is an engine, 100 is a radiator, 102 is a radiator fan, 101 is a shroud covering said radiator fan 102, 103 is an alternator, 104 is a compressor for an air conditioner, and 106 is the crankshaft center line of the engine 105.

Reference numeral 1 is a crank pulley fixed to the crankshaft of said engine 105, 107 is an air conditioner pulley fixed to the rotation shaft of said compressor 104 for air conditioner, 4 is an alternator pulley fixed to the rotation shaft of said alternator 103, and 108 is a water pump pulley fixed to the rotation shaft of a water pump (not shown in the drawings).

Reference numeral 5 is a tension pulley. Reference numeral 2 is a belt looped over said crank pulley 1, water pump pulley 108, air conditioner pulley 107, alternator pulley 4, and tension pulley 5. Torque is transmitted from said crank pulley 1 to said water pump pulley 108, air conditioner pulley 107, and alternator pulley 4 by means of said belt 2 to drive accessories such as said water pump (not shown in the drawings), compressor 104 for air conditioner, alternator 103, etc.

Reference numeral 3 is an auto-tensioner (automatic belt tension adjuster) for adjusting the tension of said belt 2. Reference numeral 15 is a supporting shaft to support said auto-tensioner, 32 is an actuator, 7 is an auto-tensiner connecting shaft connected to the moving end of said actuator 32, and 8 is a connecting arm for connecting the auto-tensioner connecting shaft 7 at the moving end of the actuator 32 to a tension pulley supporting shaft 13 supporting said tension pulley 5 for rotation. The connecting arm 8 is supported for rocking by a supporting shaft 6 attached to said engine 105.

The tension of said belt 2 can be adjusted by moving the moving end of the actuator 32 of said auto-tensioner 3. When the auto-tensioner connecting shaft 7 connected to the moving end of the actuator 32 of the auto-tensioner 3 is shifted by operating the actuator 32, the connecting arm 8 is turned around the center of the supporting shaft 6, whereby the position of the tension pulley supporting shaft 13 and the tension pulley 5 supported by the tension pulley supporting shaft 13 is changed to allow the tension of the belt 2 to be adhusted.

Reference numeral 110 is a pointer fixed to the connecting arm 8, and 111 is a scale plate fixed to the engine 105. As the pointer 110 turns together with the connecting arm and the scale plate is fixed to the engine, how much the connecting arm 8 is turned relative to the engine can be visually detected by means of the pointer 110 and scale plate 111. Thus, the travel of said tension pulley 5, which is a barometer to show how much the belt elongated plastically, can be visually detected.

### SUMMARY OF THE INVENTION

The object of the present invention is to increase the reliability of a belt tension adjusting device by reducing the bending moment exerting to a supporting shaft of a connecting arm for connecting a moving end of an actuator and a tension pulley and increasing the durability of supporting members.

To attain the object mentioned above, the present invention proposes a belt tension adjusting device for an engine comprising: a crank pulley; an accessory pulley or pulleys; a belt looped over said pulleys to transmit the torque of said crank pulley to said accessory pulley or pulleys for driving an accessory or accessories; a tension pulley pushing the belt to give tension thereto; an auto-tensioner (automatic belt tension adjuster) for adjusting belt tension automatically, the auto-tensioner comprising an actuator and a connecting arm, a fixing end of said actuator being supported by a supporting shaft attached to the body of the engine, a moving end of said actuator being connected to an end part of said connecting arm, the tension pulley being supported for rotation at the other end part of the connecting arm, the connecting arm being supported for rocking by a supporting shaft attached to the body of the engine at an intermediate position between both ends of the connecting arm so that the rotation center of said tension pulley being able to be shifted by shifting the moving end of the actuator to adjust the tension of the belt; and a reinforcing member connecting one of the fixing end of the actuator and the body of the engine to the intermediate position of the connecting arm.

According to the invention, as the reinforcing member is provided to bridge the fixing end of the actuator and the supporting portion of the connecting arm, the bending moment exerting to the connecting arm supporting shaft, the bending moment being produced by the force Fs exerting to the connecting arm from the moving end of the actuator and the force Ft exerting to the connecting arm from the tension pulley, is reduced by providing the reinforcing member which connects the supporting shaft supporting the connecting arm to the supporting shaft fixing the fixing end of the actuator, because the bending moment is borne by said two shafts. As a result, the occurrence of sticking of the bearing supporting the connecting arm and breakage of the connecting arm supporting shaft due to the bending of the connecting arm supporting shaft are prevented. Accordingly, the occurrence of engine failure resulting from failed belt transmission due to said failures is prevented.

In the invention, it is preferable that an end of the reinforcing member is supported by the connecting arm supporting shaft near the top end thereof and the other end of the reinforcing member is fixed to the engine body.

It is preferable that an end of said reinforcing member is supported together with the connecting arm by the connecting arm supporting shaft and the other end thereof is fixed together with the fixing end of the actuator to the body of the engine.

With this composition, by supporting the connecting arm supporting shaft at the position where the deflection due to the bending moment is maximum with the reinforcing member, the connecting arm supporting shaft can be supported efficiently to reduce the bending of the supporting shaft.

It is also preferable that said reinforcing member is formed to have a flat part with both end sides bent by right angles to the flat part to compose reinforcement parts.

By forming the reinforcing member like this, the reinforcing member increases in rigidity against bending, and required rigidity against bending can be obtained with thin plate material resulting in a decreased weight.

It is also preferable that said reinforcing member is formed to have the general shape of a letter “L” and located so that the longer side thereof runs along the axis of the actuator with a certain gap with the end of the longer side supported together with the connecting arm and the end part of the shorter side thereof is fixed together with the fixing end of the actuator to the body of the engine.

By composing like this, a holding tool can be inserted from the upper or front side of the engine to lock the actuator in a contracted state by compressing a spring of the auto-tensioner to a contracted state without interfering with the actuator, because the reinforcing member is located so that a gap exists between the outer surface of the actuator and the reinforcing member, and workability of replacing the belt is improved.

It is preferable in the invention that an indicating member is attached to the moving end of said actuator and a scale member is attached to the connecting arm near the supporting part thereof so that the position of the indicating member can be detected by the scale member.

With this composition, as the amount of shift of the moving end of the actuator, the amount of shift being relatively large, can be determined by observing the position of the pointer fixed to the moving end of the actuator relative to the scale member attached on the connecting arm near the supporting shaft, the amount of shift can be detected with ease, and the plastic elongation, which corresponds to the amount of the shift of the moving end of the actuator, of the belt can be determined easily by visual inspection.

It is preferable in the invention that an indicating member is attached to the moving end of said actuator and a detecting part with a belt life limit range marked thereon for indicating an operational life limit of the belt is provided to said reinforcing member at the part facing said indicating member so that it is possible to judge that the time for the belt to be replaced has come when the indicating member comes away out of the life limit range of the detecting part.

By composing like this, the time for the belt to be replaced can be easily judged only by inspecting the position on the detecting part that is being pointed by the indicating member.

### BRIEF DESCRIPTION OF THE DRAWINGS

FIG. 1 is an elevational view of the first embodiment of the belt tension adjusting device of a vehicle engine according to the present invention.

FIG. 2 is a view in the direction of arrows A-A of FIG. 1.

FIG. 3 is a partial elavational view of the first embodiment of the device showing the tension pulley and auto-tensioner.

FIG. 4 is a partial elavational view of the second embodiment of the device showing the tension pulley and auto-tensioner.

FIG. 5 is a view in the direction of arrow z in FIG. 4 showing the second embodiment.

FIG. 6 is a view of the third embodiment corresponding to FIG. 3.

FIG. 7(A) is a view of the fourth embodiment corresponding to FIG. 5, and

FIG. 7(B) is a cross-section in the direction of arrows C-C in FIG. 7(A).

FIG. 8 is a view of the fifth embodiment corresponding to FIG. 3.

FIG. 9 is a view of the fifth embodiment showing when the holding tool is attached thereto corresponding to FIG. 3.

FIG. 10 is a view of the sixth embodiment corresponding to FIG. 3.

FIG. 11 is a side view of an example of belt tension adjusting device of prior art.

FIG. 12 is an elevational view of the device shown in FIG. 11.

FIG. 13 is an elevational view of the tension pulley and auto-tensioner of the device shown in FIG. 11.

FIG. 14 an elevational view of the auto-tensioner of prior art when it is clutched by a holding tool for holding the actuator in a contracted state when replacing the belt.

FIG. 15(A) is an enlarged detail of a part indicated by arrow Y in FIG. 12, and

FIG. 15(B) is a view in the direction of arrow Z in FIG. 15(A).

### DETAILED DESCRIPTION OF THE PREFERRED EMBODIMENTS

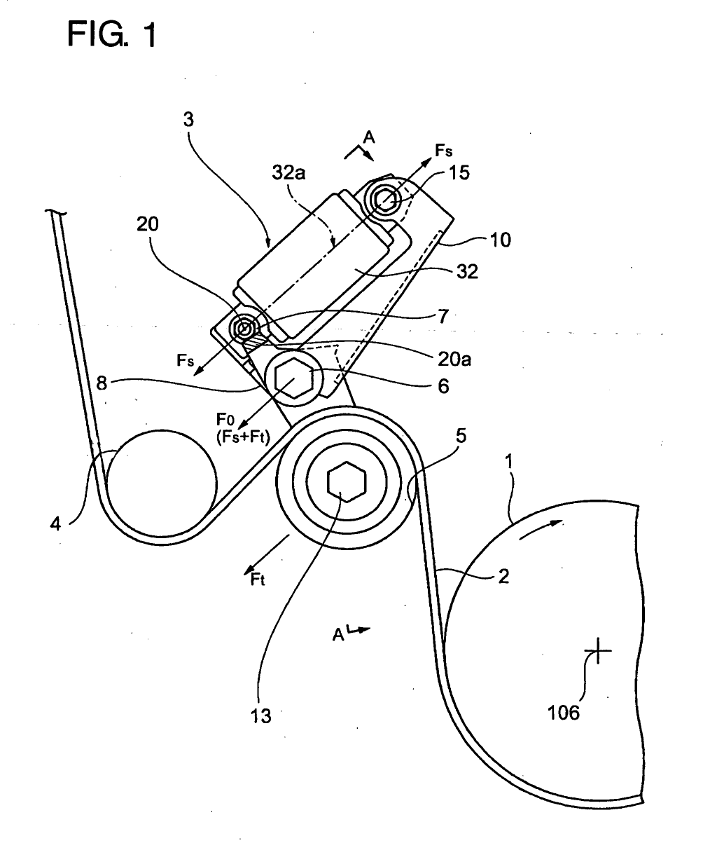

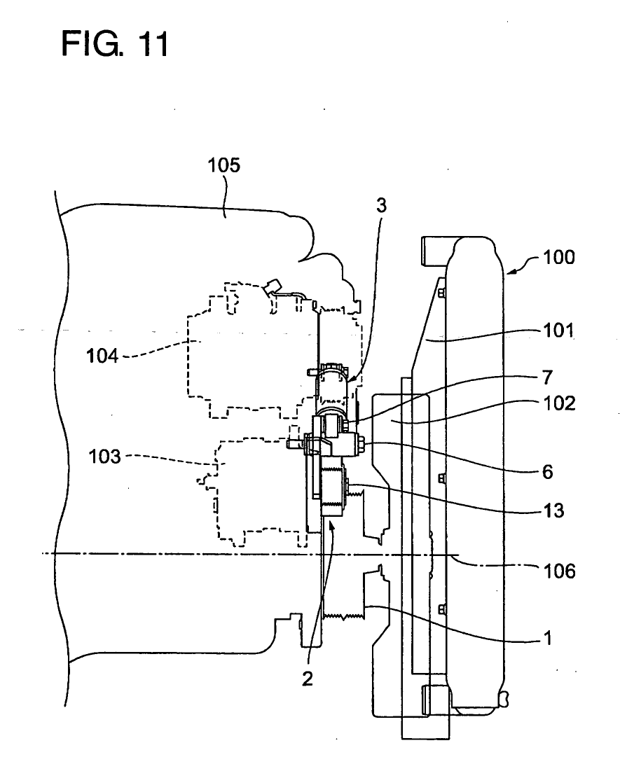

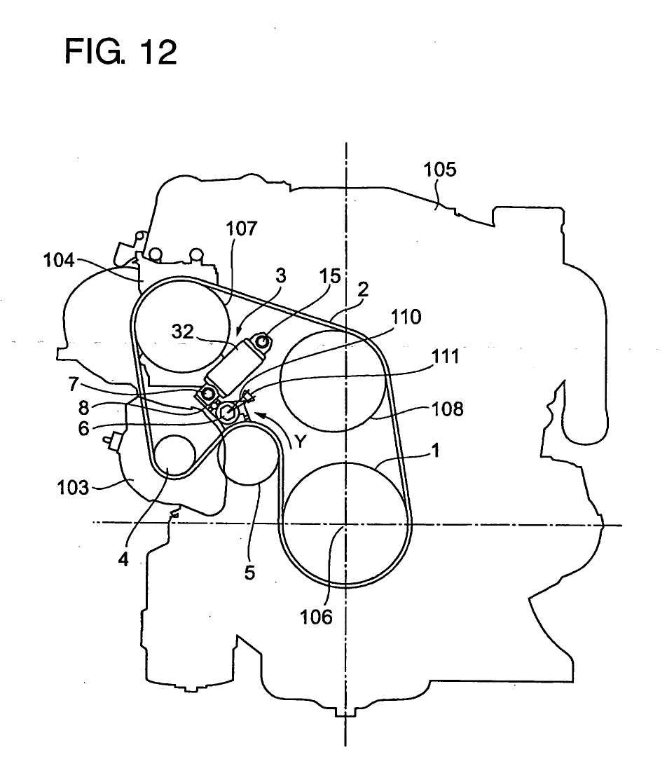

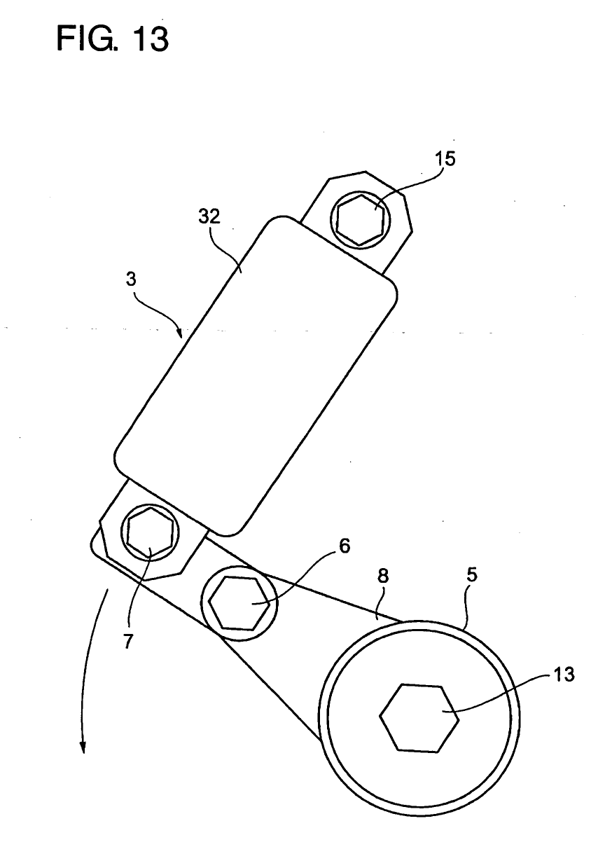

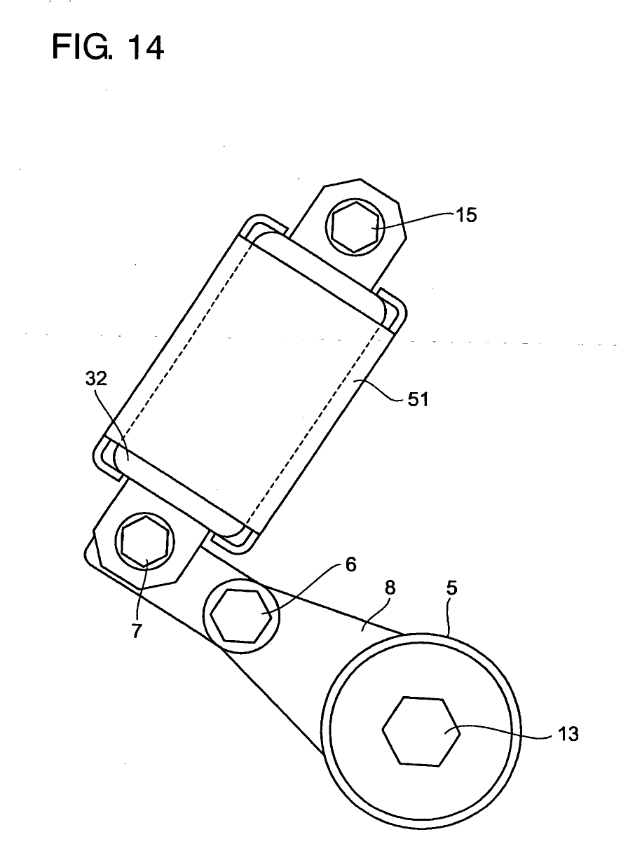

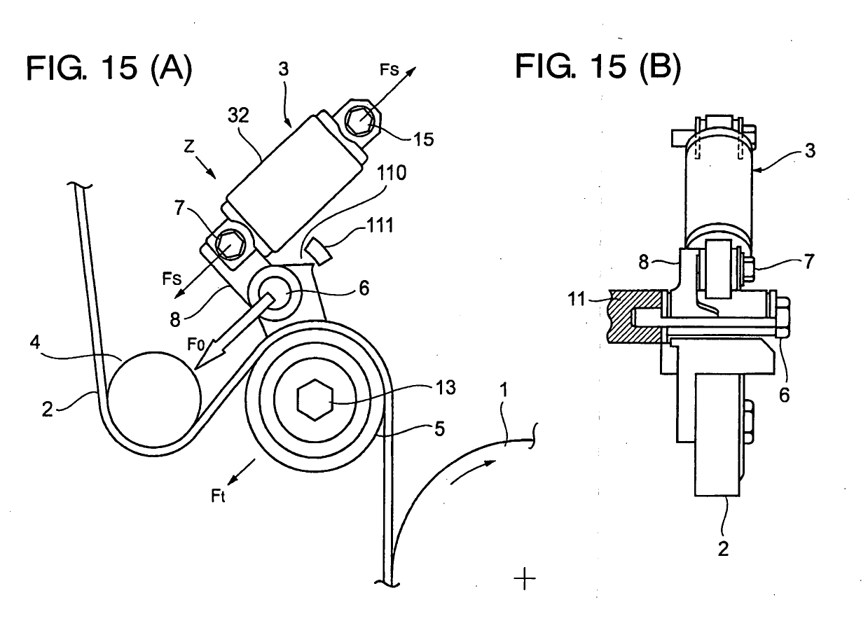

Referring to FIG. 1-FIG. 10 showing the first to sixth embodiment, the configuration and arrangement of an engine 105, radiator 100, radiator fan 102, shroud 101 for covering the radiator, alternator 103, compressor 104 for an air conditioner, crank pulley 1 fixed to the crankshaft of said engine 105, air conditioner pulley 107 fixed to the rotation shaft of said compressor 104 for air conditioner, alternator pulley 4 fixed to the rotation shaft of said alternator. 103, water pump pulley 108 fixed to the rotation shaft of a water pump (not shown in the drawings), tension pulley 5, etc. and the configuration and arrangement of a belt 2 looped over said crank pulley 1, water pump pulley 108, air conditioner pulley 107, alternator pulley 4, and tension pulley 5 are similar to the prior art shown in FIGS. 11 and 12.

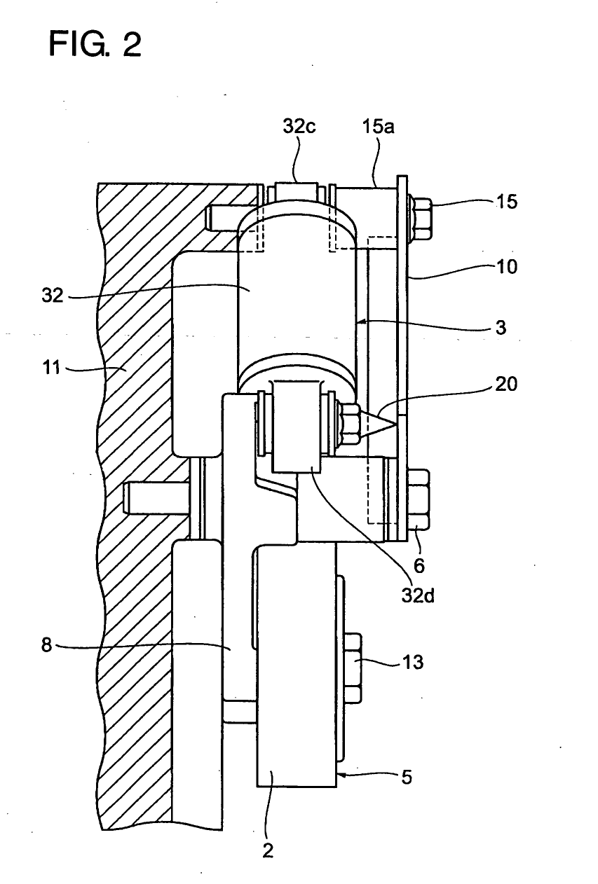

In FIG. 1 and FIG. 2 showing the first embodiment, reference numeral 1 is a crank pulley, 4 is an alternator pulley, 2 is a belt looped over said crank pulley 1, water pump pulley 108 (see FIG. 12), air conditioner pulley 107 (see FIG. 12), alternator pulley 4, and tension pulley 5. Torque is transmitted from said crank pulley I to said water pump pulley 108, air conditioner pulley 107, and alternator pulley 4 by means of said belt 2 to drive accessories such as said water pump (not shown in the drawings), compressor 104 for air conditioner (see FIG. 11), alternator 103 (see FIG. 11), etc. Reference numeral 106 is the crankshaft center line of the engine 105.

Reference numeral 3 is an auto-tentioner (automatic belt tension adjuster) for adjusting the tension of the belt 2. Reference numeral 32 is an actuator of the auto-tensioner 3. Reference numeral 15 is an autu-tensioner supporting shaft to support the fixing end of the actuator 32, said auto-tensionar 3 being fixed to the body part 11 of said engine 105 (see FIG. 11) by the supporting shaft 15. Reference numeral 7 is an auto-tensioner connecting shaft attached to the moving end of said actuator 32. Reference numeral 13 is a tension pulley supporting shaft which supports said tension pulley 5 for rotation.

Reference numeral 8 is a connecting arm, which is supported by a supporting shaft 6 attached to the body part 11 of the engine at a center part thereof to be capable of rocking motion and which supports said auto-tensioner connecting shaft 7 at an end thereof and said tension pulley supporting shaft 13 at the other end thereof so that the movement of the moving end of said actuator 32 is transmitted to change the center position of said tension pulley 5.

When the belt 2 elongates plastically, which induces a reduction in belt tension, the moving end of the actuator 32 and accordingly the auto-tensioner connecting shaft 7 is shifted by the spring force of a spring (not shown in the drawings) in the auto-tensioner 3 by a length corresponding to the reduction in the belt tension. Said connecting arm 8 is turned around the center of the supporting shaft 6 by the shift of the auto-tensioner connecting shaft 7, and said tension pulley supporting shaft 13 and accordingly the tension pulley 5 supported by the tension pulley supporting shaft 13 is shifted to adjust the tension of the belt 2. In this way, the tension of the belt 2 is corrected automatically.

Reference numeral 10 is a plate-like reinforcing member. An end of the reinforcing member 10 is supported by the supporting shaft 6 attached to the body part 11 of the engine together with the connecting arm 8 and the other end is fixed to the body part 11 of the engine together with a fixing end 32c of the actuator 32 by means of the auto-tensioner supporting shaft 15. As shown in FIG. 1, the reinforcing member 10 extends from the supporting of the connecting arm 8 along the axis 32a of the actuator 32 and crooked near the auto-tensioner supporting shaft 15 to form the general shape of a letter “L” inverted and fixed to the engine body together with the fixing end 32 of the actuator 32.

As mentioned above, since an end of the reinforcing member 10 is supported by the engine body together with the connecting arm 8 by means of the connecting arm supporting shaft 6 at the intermediate position of the connecting arm 8 and the other end of the reinforcing member 10 is fixed to the engine body together with the fixing end 32 of the actuator 32 by means of the auto-tensioner supporting shaft 15, it is not needed to provide a fixing member to fix the reinforcing member 10 to the engine body, which allows to save manufacturing cost and to reduce the space for providing the reinforcing member 10.

According to the embodiment, the reinforcing member 10 is provided to bridge the top end part of the fixing end 32c of the actuator 32 and the top end part of the connecting arm supporting shaft 6 as shown in FIG. 2.

Reference numeral 15a is a spacer, and 22 is a supporting boss of the connecting arm 8. The force F0 exerting to the supporting shaft 6 is the sum of the force Fs which the moving end of the actuator 32 exerts to the auto-tensioner connecting shaft 7 and the force Ft which is exerted to the tension pulley supporting shaft 13 due to the tension of the belt 2, i.e. F0=Fs+Ft. A part of the force F0 is transmitted through the reinforcing member 10 to the auto-tensioner supporting shaft 15, so that the bending moment exerting to the supporting shaft 6 is reduced.

By this, the occurrence of sticking of the bearing supporting the connecting arm 8 and breakage of the supporting shaft 6 due to the bending of the supporting shaft 6 are prevented. Accordingly, the occurrence of engine failure resulting from failed belt transmission due to said-failures is prevented.

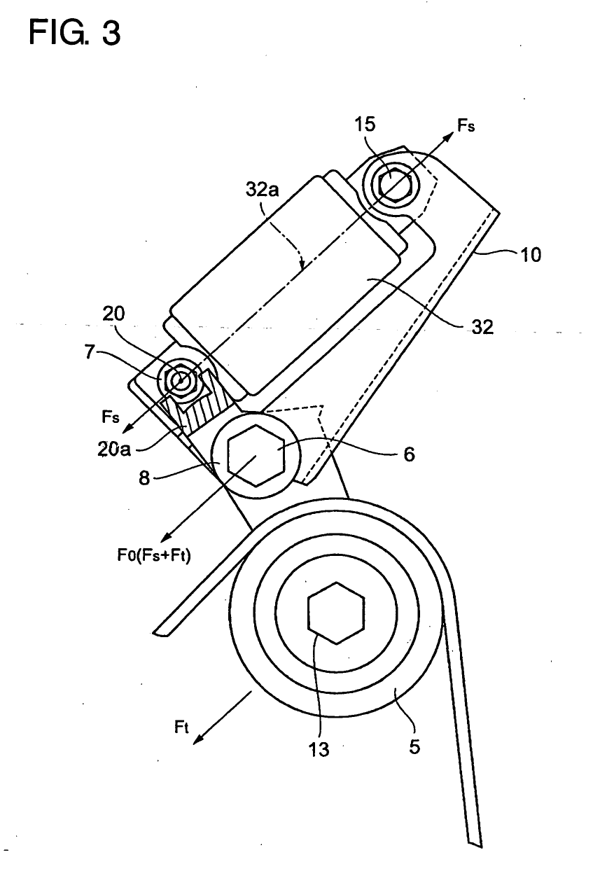

Referring to FIGS. 1-3, reference numeral 20 is a pointer as an indicating part fixed to the moving end 32d of the actuator 32. The supporting shaft-side end of the reinforcing member 10 extends from the supporting point of the connecting arm 8 toward the pointer 20 and a detecting part 20a facing the pointer 20 is formed to be of a width corresponding to the limit range of operating life of the belt with a coating applied on the surface. The detecting part 20a is hatched in FIG. 1 and FIG. 3.

With this composition, the time for the belt to be replaced can be judged by detecting that the pointer 20 comes away out of the belt life limit range of the detecting part 20a. As the coating is applied to the detecting part 20a, it can be easily detected.

Therefore, the time for the belt 2 to be replaced can be easily judged only by detecting the position of the pointer 20 attached to the moving end 32d of the actuator 32 relative to the detecting part 20a provided on an end part of the reinforcing member 10, and as the detecting part 20a is applied with a coating, visibility is improved making detection easy.

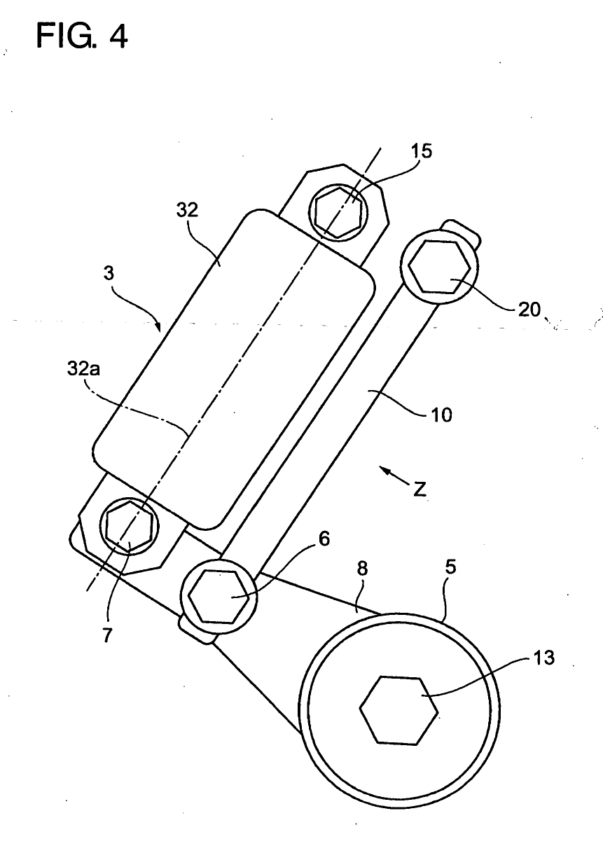

The second to sixth embodiment shown in FIGS. 4 to 10 are examples of modification in reinforcing members and attaching position thereof, and are similar in composition to the device of the first embodiment except said modifications.

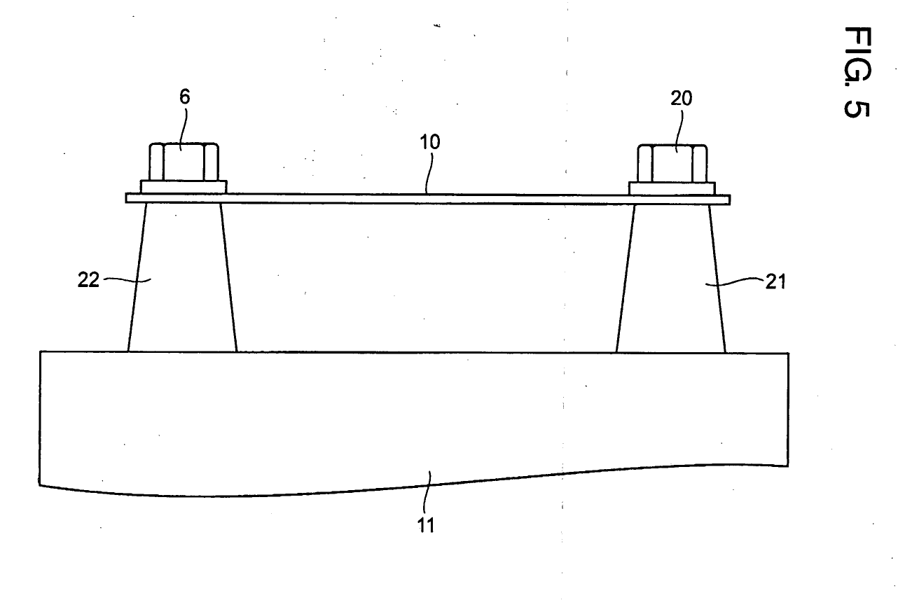

In FIGS. 4 and 5 showing the second embodiment, the reinforcing member 10 is attached so that an end thereof is fixed to the top face of a fixing boss 21 formed to protrude from the engine body 11 by means of a bolt 20 and the other end is supported by the connecting arm supporting shaft 6 near the top face of a supporting boss 22, that is, near the top end of the supporting shaft 6.

According to the second-embodiment, the bending moment exerting to the supporting shaft 6 is reduced by virtue of the reinforcing member 10 supporting the connecting arm supporting shaft 6 near the top end thereof. In this case, both end parts of the supporting shaft 6 are supported by the engine body 11, deflection of the supporting shaft 6 due to the force F0 exerting to the supporting shaft 6 is much reduced, and durability and reliability of the device is further improved.

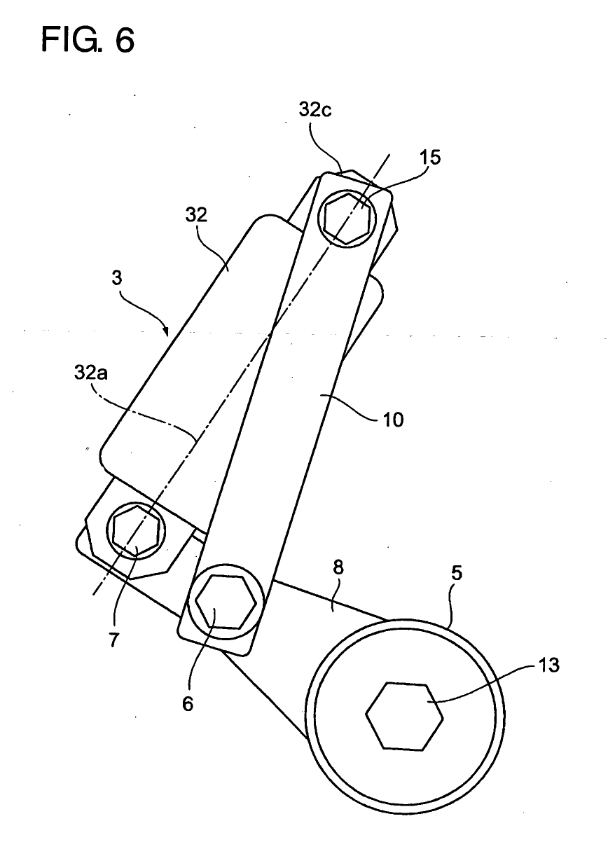

With the third embodiment shown in FIG. 6, the reinforcing member 10 is made of a flat plate, an end thereof is supported by the supporting shaft 6 supporting connecting arm 8 at the intermediate position thereof together therewith by the engine body 11, and the other end is fixed to the engine body together with the fixing end 32c of the actuator 32 by means of the auto-tensioner supporting shaft 15. With this composition, it is not needed to provide additional fixing member to fix the reinforcing member to the engine body 11, and as the reinforcing member 10 is made of a flat plate, the reinforcing member 10 can be obtained at low cost and also the reinforcing member 10 occupies only a small space.

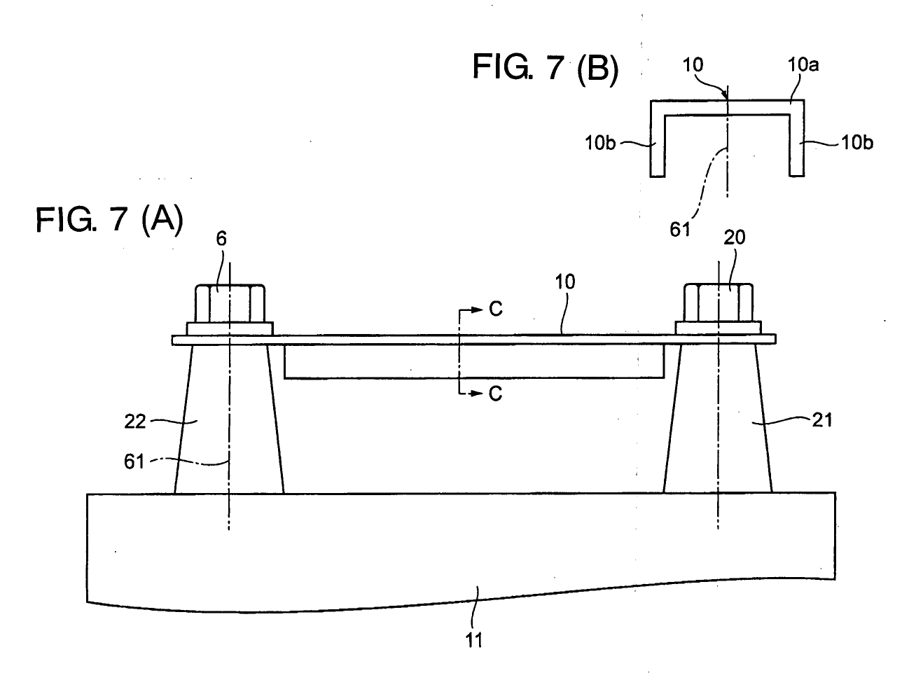

With the fourth embodiment shown in FIG. 7(A) and FIG. 7(B), the reinforcing member 10 is formed to have a flat part with both end sides bent by right angles to the flat part to compose reinforcement parts as shown in FIG. 7(B). With this shape of the reinforcing member 10, it has an increased rigidity for bending, and required bending rigidity can be secured with thin plate resulting in light weight.

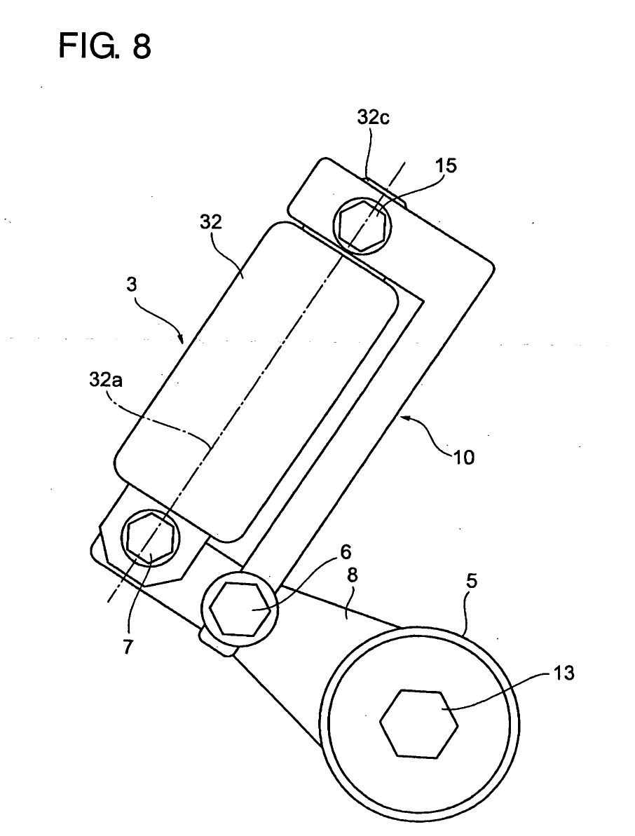

With the fifth embodiment shown in FIG. 8, the reinforcing member is formed to have the general shape of a letter “L” inverted and disposed outside of the actuator 32 so that the longer side thereof runs parallel to the center axis 32a of the actuator 32 with a certain gap between the outer surface of the actuator 32, the end of the longer side being fixed to the engine body 11 together with the connecting arm 8 by means of the connecting arm supporting shaft 6, the end of the shorter side crooked toward the actuator 32 near the fixing end of the actuator 32 being fixed to the engine body together with the fixing end 32c of the actuator 32 by mean of the auto-tensiner supporting shaft 15.

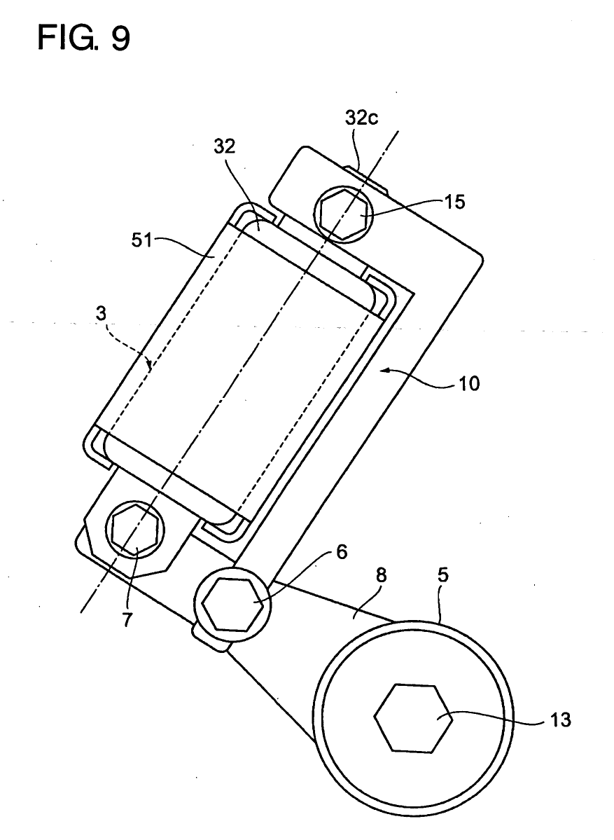

According to the fifth embodiment, a holding tool 51 can be inserted from the upper or front side of the engine to lock the actuator 32 in a contracted state, in which the spring (not shown in the drawing) of the auto-tensioner 3 is compressed to a contracted state, without interfering with the actuator 32 because of the gap between the outer surface of the actuator and the reinforcing member 10 as shown in FIG. 9, and workability of replacing the belt is improved.

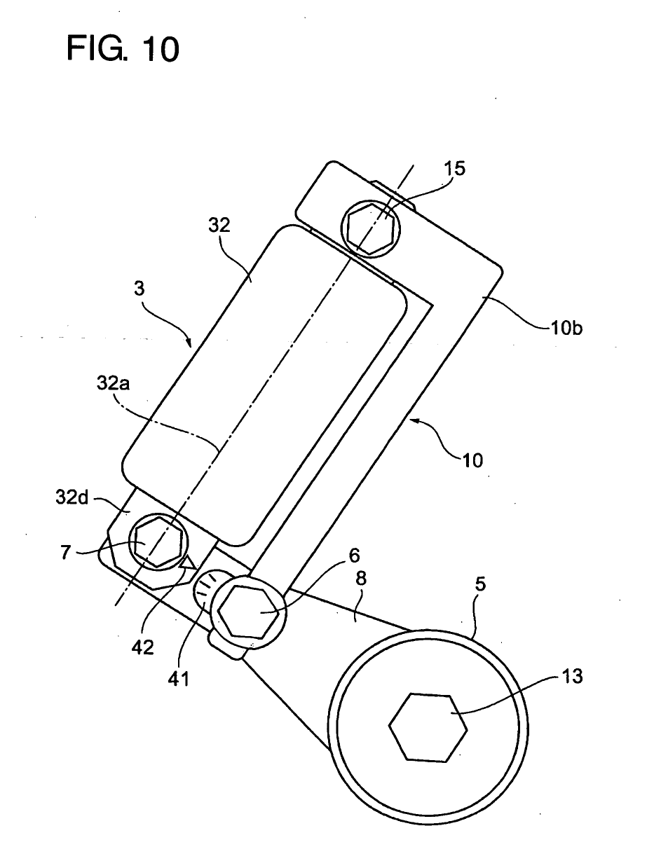

With the sixth embodiment shown in FIG. 10, a pointer 42 as an indicating part is attached to the moving end 32d of the actuator 32, and a scale member 41 is attached to the connecting arm 8 near the supporting shaft 6 supporting the reinforcing member 10 together with the connecting arm 8 so that the position of the pointer can be detected.

According to the sixth embodiment, as the amount of shift of the moving end 32d of the actuator 32, the amount of shift being relatively large, can be determined by observing the position of the pointer 42 fixed to the moving end 32d of the actuator 32 relative to the scale member 41 attached on the connecting arm 8 near the supporting shaft 6, the amount of shift can be detected with ease, and the plastic elongation, which corresponds to the amount of the shift of the moving end of the actuator, of the belt can be determined easily by visual inspection.

1. A belt tension adjusting device for an engine comprising:
a crank pulley,
an accessory pulley or pulleys,
a belt looped over said pulleys to transmit the torque of said crank pulley to said accessory pulley or pulleys for driving an accessory or accessories,
a tension pulley pushing the belt to give tension thereto,
an auto-tensioner (automatic belt tension adjuster) for adjusting belt tension automatically, the auto-tensioner comprising an actuator and a connecting arm, a fixing end of said actuator being supported by a supporting shaft attached to the body of the engine, a moving end of said actuator being connected to an end part of said connecting arm, the tension pulley being supported for rotation at the other end part of the connecting arm, the connecting arm being supported for rocking by a supporting shaft attached to the body of the engine at an intermediate position between both ends of the connecting arm so that the rotation center of said tension pulley being able to be shifted by shifting the moving end of the actuator to adjust the tension of the belt, and
a reinforcing member connecting one of the fixing end of the actuator and the body of the engine to the intermediate position of the connecting arm.

2. The belt tension adjusting device according to claim 1, wherein an end of the reinforcing member is supported by the connecting arm supporting shaft near the top end thereof.

3. The belt tension adjusting device according to claim 2, wherein an end of said reinforcing member is supported together with the connecting arm by the connecting arm supporting shaft and the other end thereof is fixed together with the fixing end of the actuator to the actuator.

4. The belt tension adjusting device according to claim 1, wherein said reinforcing member is formed to have a flat part with both end sides bent by right angles to the flat part to compose reinforcement parts.

5. The belt tension adjusting device according to claim 1, wherein said reinforcing member is formed to have the general shape of a letter “L” and located so that the longer side thereof runs along the axis of the actuator with a certain gap with the end of the longer side supported together with the connecting arm and the end part of the shorter side thereof is fixed together with the fixing end of the actuator to the body of the engine.

6. The belt tension adjusting device according to claim 1, wherein an indicating member is attached to the moving end of said actuator and a scale member is attached to the connecting arm near the supporting part thereof so that the position of the indicating member can be detected by the scale member.

7. The belt tension adjusting device according to claim 1, wherein an indicating member is attached to the moving end of said actuator and a detecting part with a belt life limit range marked thereon for indicating an operational life limit of the belt is provided to said reinforcing member at the part facing said indicating member so that it is possible to judge that the time for the belt to be replaced has come when the indicating member comes away out of the life limit range of the detecting part.
